(19) United States
(12) Patent Application Publication
(10) Pub. No.: US 2024/0141198 A1
(43) Pub. Date: May 2, 2024

(54) SEPARATOR COATING FOR LI-ION BATTERIES BASED ON PVDF ACRYLATE LATEX

(71) Applicant: Arkema France, Colombes (FR)

(72) Inventors: Francois BEAUME, Pierre-Benite (FR); Anthony BONNET, Colombes (FR); Thomas FINE, Colombes (FR); Keisuke YAMADA, Shimo Gyo-Ku Kyoto (JP); Denis KATO DE ALMEIDA, King of Prussia, PA (US); Yuanqin LIU, King of Prussia, PA (US)

(21) Appl. No.: 18/280,485

(22) PCT Filed: Mar. 21, 2022
(86) PCT No.: PCT/FR2022/050518

§ 371 Date: Sep. 6, 2023

(30) Foreign Application Priority Data
Mar. 23, 2021 (FR) FR21.02901

(51) Int. Cl. C09D 151/00; C08F 259/08; H01G 11/06; H01G 11/52; H01M 10/0525; H01M 50/403; H01M 50/42; H01M 50/426; H01M 50/431; H01M 50/446

(52) U.S. Cl. CPC C09D 151/003; C08F 259/08; H01G 11/06; H01G 11/52; H01M 10/0525; H01M 50/403; H01M 50/42; H01M 50/426; H01M 50/431; H01M 50/446

(57) ABSTRACT

The invention relates to a coating based on a fluoro acrylate polymer latex comprising inorganic particles, said coating exhibiting a very good compromise between, on the one hand, dry adhesion and adhesion in the wet state, and, on the other hand, between adhesion and ionic conductivity. This coating is intended for a separator application, in particular for Li-ion batteries. The invention also relates to a Li-ion battery comprising a separator covered with such a coating.

### FIELD OF THE INVENTION

The present invention relates generally to the field of electrical energy storage in rechargeable secondary batteries of Li-ion type. More precisely, the invention relates to a coating based on a fluoro acrylate polymer latex comprising inorganic particles, said coating exhibiting a very good compromise between, on the one hand, dry adhesion and adhesion in the wet state, and, on the other hand, between adhesion and ionic conductivity. This coating is intended for a separator application, in particular for Li-ion batteries. The invention also relates to a Li-ion battery comprising a separator covered with such a coating.

### TECHNICAL BACKGROUND

The market for separators for electrochemical devices is dominated by the use of polyolefins (for example Celgard® or Hipore) produced by extrusion and/or drawing via dry or wet processes. Separators have to simultaneously exhibit low thicknesses, an optimum affinity for the electrolyte and a satisfactory mechanical strength and temperature resistance. Among the most advantageous alternatives to polyolefins, polymers exhibiting a better affinity with regard to standard electrolytes have been proposed, in order to reduce the internal resistances of the system, such as poly(methyl methacrylate) (PMMA), poly(vinylidene fluoride) (PVDF) and poly(vinylidene fluoride-co-hexafluoropropene) (P(VDF-co-HFP)). Another option consists in depositing a coating on one or two faces of the polyolefin separator.

The main evaluation criteria for a coating for a separator are: dry adhesion, adhesion in the wet state, ionic conductivity and heat stability.

Dry adhesion is measured after assembly, by pressing or lamination, of the coated separator with an electrode. This adhesion increases with the temperature and the pressure applied after coating. However, it is desirable to use gentle pressing/lamination conditions: a reduced pressure to avoid/limit the closure of the pores and hence to minimize the impact on the ionic conductivity, and a moderate temperature to limit the energy consumption and maintain a high line speed/productivity.

The adhesion of the coating on the separator in the wet state is measured after impregnation with the electrolyte. This adhesion decreases when the coating is softened by electrolyte solvents, leading to the swelling of the polymer present in the coating, possibly even the dissolution of the coating. The percentage of swelling or even dissolution or the loss of integrity are used as a first indication of the adhesion performance in the wet state.

The ionic conductivity represents the migration of the Li ions through the separator and its coating by virtue of the porosity. In coating via the aqueous route, this porosity corresponds to the interstices between the solid particles which make up the coating: polymer particles (from the latex or from a powder re-dispersed in water) and/or ceramic particles. In coating via the solvent route, this porosity is created by the phase inversion (exposure of the acetone-based coating to moisture, for example) required prior to or during drying; without phase inversion, simple evaporation of the solvent forms a continuous nonporous coating. The Gurley air permeability is used as a first indication of ionic conduction. Beyond the air permeability of the initial coated separator, other aspects may affect the ionic conductivity: interaction with the electrolyte (favourable when a slight swelling of the polymer makes it possible to improve wettability/affinity for the electrolyte, unfavourable when excessive swelling of the polymer leads to a reduction in size/clogging of the pores), the effect of the pressing or lamination (reduces the size of/clogs the pores).

The heat stability is low for polyolefin separators alone (made of PE or PP or PP/PE/PP multilayer), which exhibit significant temperature shrinkage. The thermal stability can be markedly improved by a coating containing inorganic particles.

Poly(vinylidene fluoride) (PVDF) and its derivatives exhibit an advantage as main constituent material of the separator and also as polyolefin separator coating, for their electrochemical stability and for their high dielectric constant, which promotes the dissociation of the ions and thus the conductivity. The crystallinity of P(VDF-co-HFP) copolymer (copolymer of vinylidene fluoride (VDF) and hexafluoropropylene (HFP)) is lower than that of PVDF. For this reason, the advantage of these P(VDF-co-HFP) copolymers is that they promote conductivity.

Mixtures of PVDF latex and acrylic latex, for an application as separator coating, are known. The document US 2018/0233727 describes a separator for a battery, containing a porous substrate and a porous adhesive layer which is provided on one side or on both sides of the porous substrate and contains a mixture of an acrylic-type resin comprising styrene and of a polyvinylidene fluoride-type resin, the content of the acrylic-type resin in the porous adhesive layer being from 2% to 40% by mass relative to a total mass of the acrylic-type resin and of the polyvinylidene fluoride-type resin. This separator exhibits good adhesion to an electrode by dry hot pressing. However, the preparation of the coating requires a prior step of dissolution of the PVDF and of the acrylic polymer in a common solvent (dimethylacetamide and tripropylene glycol), which makes the process more laborious and more difficult to apply on the industrial scale with significant environmental constraints.

There therefore remains a need to develop novel coatings for separators which are easy to implement and which exhibit a good compromise between dry adhesion, adhesion in the wet state, ionic conductivity and heat stability.

The aim of the invention is thus to overcome at least one of the drawbacks of the prior art, namely to propose a polymeric coating for a separator which is able to prevent the swelling or dissolution in an electrolyte solvent/electrolyte solvents while retaining good adhesion properties and a good ionic conductivity.

The invention is also aimed at providing a process for manufacturing this polymeric coating via the aqueous route.

Another subject of the invention is a separator for an electrochemical device such as a battery, a capacitor, an electrical double-layer capacitor, a membrane-electrode assembly (MEA) for a fuel cell, especially a separator for a Li-ion secondary battery, comprising said coating.

Lastly, the invention is aimed at providing electrochemical devices such as a rechargeable Li-ion secondary battery, a capacitor, an electrical double-layer capacitor, a membrane-electrode assembly (MEA) for a fuel cell, comprising such a separator.

### SUMMARY OF THE INVENTION

The invention has the object of providing a material having an improved adhesive property for a separator coating when it is used in an electronic device application, especially lithium-ion battery. The material is used as a polymeric binder or adhesion component on the separator.

Surprisingly, it has been found that a hybrid latex, consisting of particles containing both a fluoropolymer and an acrylic polymer, and admixed with inorganic particles, provides a better compromise of properties used as monolayer coating via the aqueous route, compared to known coatings.

The invention firstly relates to a monolayer coating for a separator, said coating containing a hybrid fluoro-acrylic polymer resin and inorganic particles, the fluoropolymer part of said resin being based on vinylidene difluoride.

The hybrid fluoro-acrylic polymer resin is in the form of a latex, defined as being a colloidal dispersion of polymers dispersed in a continuous (generally aqueous) phase. The latex particles exhibit a morphology of interpenetrating network (IPN) type with chains of fluoropolymer and of acrylic polymer being intimately intermingled. The hybrid fluoro-acrylic polymer resin comprises a fluoropolymer modified with an acrylic polymer. Said fluoropolymer, based on polyvinylidene fluoride, is chosen from the group of polyvinylidene fluoride homopolymers and copolymers based on polyvinylidene fluoride and on at least one comonomer compatible with vinylidene fluoride, especially with hexafluoropropylene. The acrylic phase of the resin may contain monomer residues having functional groups which allows the acrylic phase to undergo crosslinking.

The invention also relates to a separator for an electrochemical device chosen from the group: Li-ion battery, capacitor, electrical double-layer capacitor, and membrane-electrode assembly for a fuel cell, said separator comprising a porous support and at least one monolayer coating as defined above.

According to one embodiment, said separator is suitable for use in a rechargeable Li-ion battery.

Another subject of the invention is an electrochemical device chosen from the group: Li-ion battery, capacitor, electrical double-layer capacitor, and membrane-electrode assembly (MEA) for a fuel cell, comprising said separator.

Lastly, the invention relates to a Li-ion battery comprising a negative electrode, a positive electrode and a separator, wherein said separator comprises a porous support and at least one monolayer coating as defined above.

The present invention makes it possible to overcome the drawbacks of the prior art. More particularly, it provides a monolayer adhesive coating for a separator which is capable of preventing excessive swelling or dissolution in an electrolyte solvent/electrolyte solvents while retaining good properties of adhesion to the support of the separator and to an electrode, good permeability and good ionic conductivity.

### DESCRIPTION OF EMBODIMENTS OF THE INVENTION

The invention is now described in more detail and in a nonlimiting way in the description which follows.

According to a first aspect, the invention relates to a monolayer coating for a separator, said coating containing a hybrid fluoro-acrylic polymer resin and inorganic particles.

According to various implementations, said coating comprises the following features, in combination where appropriate. The contents indicated are expressed by weight, unless otherwise indicated. For all the indicated ranges, the limits are included unless otherwise indicated.

The hybrid fluoro-acrylic polymer resin consists of a fluoro acrylate polymer. The fluoropolymers used in the invention as seed for the acrylic polymerization are based on vinylidene difluoride and are denoted generically with the abbreviation PVDF.

According to one embodiment, the PVDF is homopolymeric poly(vinylidene fluoride).

According to one embodiment, the PVDF is a copolymer of vinylidene difluoride with at least one comonomer compatible with vinylidene difluoride.

The comonomers compatible with vinylidene difluoride can be halogenated (fluorinated, chlorinated or brominated) or non-halogenated.

Examples of appropriate fluorocomonomers are: vinyl fluoride, tetrafluoroethylene, hexafluoropropylene, trifluoropropenes and in particular 3,3,3-trifluoropropene, tetrafluoropropenes and in particular 2,3,3,3-tetrafluoropropene or 1,3,3,3-tetrafluoropropene, hexafluoroisobutylene, perfluorobutylethylene, pentafluoropropenes and in particular 1,1,3,3,3-pentafluoropropene or 1,2,3,3,3-pentafluoropropene, perfluoroalkyl vinyl ethers and in particular those of general formula Rf—O—CF═CF₂, Rf being an alkyl group, preferably a C1 to C4 alkyl group (preferred examples being perfluoropropyl vinyl ether and perfluoromethyl vinyl ether).

The fluorocomonomer may comprise a chlorine or bromine atom. It can in particular be chosen from bromotrifluoroethylene, chlorofluoroethylene, chlorotrifluoroethylene and chlorotrifluoropropene. Chlorofluoroethylene can denote either 1-chloro-1-fluoroethylene or 1-chloro-2-fluoroethylene. The 1-chloro-1-fluoroethylene isomer is preferred. Chlorotrifluoropropene is preferably 1-chloro-3,3,3-trifluoropropene or 2-chloro-3,3,3-trifluoropropene.

The VDF copolymer may also comprise non-halogenated monomers such as ethylene and/or acrylic or methacrylic comonomers.

The fluoropolymer preferably contains at least 50 mol % vinylidene difluoride.

According to one embodiment, the PVDF is a copolymer of vinylidene fluoride (VDF) and of hexafluoropropylene (HFP) (P(VDF-HFP)), having a percentage by weight of hexafluoropropylene monomer units of from 2% to 23%, preferably from 4% to 15% by weight relative to the weight of the copolymer.

According to one embodiment, the PVDF is a copolymer of vinylidene fluoride and of tetrafluoroethylene (TFE).

According to one embodiment, the PVDF is a copolymer of vinylidene fluoride and of chlorotrifluoroethylene (CTFE).

According to one embodiment, the PVDF is a VDF-TFE-HFP terpolymer. According to one embodiment, the PVDF is a VDF-TrFE-TFE terpolymer (TrFE being trifluoroethylene). In these terpolymers, the content by mass of VDF is at least 10%, the comonomers being present in variable proportions.

According to one embodiment, the PVDF comprises monomer units bearing at least one of the following functions: carboxylic acid, carboxylic acid anhydride, carboxylic acid ester, epoxy groups (such as glycidyl), amide, hydroxyl, carbonyl, mercapto, sulfide, oxazoline, phenolic, ester, ether, siloxane, sulfonic, sulfuric, phosphoric or phosphonic. The function is introduced by a chemical reaction which can be grafting or a copolymerization of the fluoromonomer with a monomer bearing at least one of said functional groups and a vinyl function capable copolymerizing with the fluoromonomer, according to techniques well known to a person skilled in the art.

According to one embodiment, the functional group bears a carboxylic acid function which is a group of (meth)acrylic acid type chosen from acrylic acid, methacrylic acid, hydroxyethyl (meth)acrylate, hydroxypropyl (meth)acrylate and hydroxyethylhexyl (meth)acrylate.

According to one embodiment, the units bearing the carboxylic acid function additionally comprise a heteroatom chosen from oxygen, sulfur, nitrogen and phosphorus.

According to one embodiment, the functionality is introduced by means of the transfer agent used during the synthesis process. The transfer agent is a polymer of molar mass less than or equal to 20 000 g/mol and bearing functional groups chosen from the groups: carboxylic acid, carboxylic acid anhydride, carboxylic acid ester, epoxy groups (such as glycidyl), amide, hydroxyl, carbonyl, mercapto, sulfide, oxazoline, phenolic, ester, ether, siloxane, sulfonic, sulfuric, phosphoric or phosphonic. One example of a transfer agent of this type is oligomers of acrylic acid. According to a preferred embodiment, the transfer agent is an oligomer of acrylic acid of molar mass less than or equal to 20 000 g/mol.

The content of functional groups of the PVDF is at least 0.01 mol %, preferably at least 0.1 mol %, and at most 15 mol %, preferably at most 10 mol %.

The PVDF preferably has a high molecular weight. The term “high molecular weight”, as used here, is understood to mean a PVDF having a melt viscosity of greater than 100 Pa·s, preferably of greater than 500 Pa·s, more preferably of greater than 1000 Pa·s, according to the ASTM D-3835 method, measured at 232° C. and 100 sec⁻¹.

The PVDF homopolymers and the VDF copolymers used in the invention can be obtained by known polymerization methods, such as emulsion or suspension polymerization.

According to one embodiment, they are prepared by an emulsion polymerization process in the absence of a fluorinated surface-active agent.

The polymerization of the PVDF results in a latex generally having a solids content of from 10% to 60% by weight, preferably from 10% to 50%, and having a weight-average particle size of less than 1 micrometre, preferably less than 1000 nm, preferably of less than 800 nm and more preferably of less than 600 nm. The weight-average size of the particles is generally at least 20 nm, preferably at least 50 nm, and advantageously the average size is within the range from 100 to 400 nm. The polymer particles can form agglomerates, the weight-average size of which is from 1 to 30 micrometres and preferably from 2 to 10 micrometres. The agglomerates can break up into discrete particles during the formulation and the application to a substrate.

According to some embodiments, the PVDF homopolymer and the VDF copolymers are composed of biobased VDF. The term “biobased” means “resulting from biomass”. This makes it possible to improve the ecological footprint of the membrane. Biobased VDF can be characterized by a content of renewable carbon, that is to say of carbon of natural origin and originating from a biomaterial or from biomass, of at least 1 atom %, as determined by the content of ¹⁴C according to Standard NF EN 16640. The term “renewable carbon” indicates that the carbon is of natural origin and originates from a biomaterial (or from biomass), as indicated below. According to some embodiments, the biocarbon content of the VDF can be greater than 5%, preferably greater than 10%, preferably greater than 25%, preferably greater than or equal to 33%, preferably greater than 50%, preferably greater than or equal to 66%, preferably greater than 75%, preferably greater than 90%, preferably greater than 95%, preferably greater than 98%, preferably greater than 99%, advantageously equal to 100%.

The hybrid fluoro-acrylic polymer resin is synthesized by emulsion polymerization of acrylate/methacrylate monomers using a latex of said fluoropolymer as seed, which affords a hybrid fluoro-acrylic polymer composition. The acrylic part of the fluoropolymer modified with the acrylic is optionally capable of crosslinking (depending on the choice of acrylic monomers used).

According to one embodiment, the alkyl acrylate with an alkyl group having from 1 to 18 carbon atoms, used as monomer for emulsion polymerization in the presence of the particles of PVDF polymer, comprises: methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, and n-octyl acrylate. Among these, alkyl acrylates with an alkyl group having from 1 to 8 carbon atoms are preferred, and alkyl acrylates with an alkyl group having from 1 to 5 carbon atoms are more preferable. These compounds may be used alone or as a mixture of two or more.

The term “acrylate” here encompasses acrylates and methacrylates.

The optional ethylenically unsaturated compound which is copolymerizable with the alkyl acrylate and the alkyl methacrylate comprises:
(A) an alkenyl compound containing a functional group, and
(B) an alkenyl compound without a functional group.

The alkenyl compound (A) containing a functional group comprises, for example, α,β-unsaturated carboxylic acids such as acrylic acid, methacrylic acid, fumaric acid, crotonic acid, itaconic acid and the like; vinyl ester compounds such as vinyl acetate, vinyl neodecanoate and the like; amide compounds such as acrylamide, methacrylamide, N-methylacrylamide, N-methylmethacrylamide, N-methylolacrylamide, N-methylolmethacrylamide, N-alkylacrylamide, N-alkylmethacrylamide, N,N-dialkylacrylamide, N,N-dialkylmethacrylamide, diacetone acrylamide and the like; acrylic acid esters such as 2-hydroxyethyl acrylate, N-dialkylaminoethyl acrylate, glycidyl acrylate, n-dodecyl acrylate, fluoroalkyl acrylate and the like; methacrylic acid esters such as dialkylaminoethyl methacrylate, fluoroalkyl methacrylate, 2-hydroxyethyl methacrylate, n-octyl methacrylate, t-butyl methacrylate, glycidyl methacrylate, ethylene glycol dimethacrylate and the like; maleic anhydride, and alkenyl glycidyl ether compounds such as allyl glycidyl ether and the like. Among these, preference is given to acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether. These compounds may be used alone or as a mixture of two or more.

The alkenyl compound without functional group (B) comprises, for example, conjugated dienes such as 1,3-butadiene, isoprene and the like; divinyl hydrocarbon compounds such as divinylbenzene and the like; and alkenyl cyanides such as acrylonitrile, methacrylonitrile and the like. Among these, 1,3-butadiene and acrylonitrile are preferred. These compounds may be used alone or as a mixture of two or more.

It is preferable for the functional alkenyl compound (A) to be used in a proportion of less than 50% by weight relative to the weight of the mixture of monomers and for the alkenyl compound without functional group (B) to be used in a proportion of less than 30% by weight relative to the weight of the mixture of monomers.

According to one embodiment, the acrylic-modified fluoropolymer resin used within the context of the invention may undergo crosslinking either by self-condensation of its functional groups or by reaction with a catalyst and/or a crosslinking agent, such as melamine resins, epoxy resins and the like, and also known crosslinking agents of low molecular weight such as di- or higher polyisocyanates, polyaziridines, polycarbodiimides, polyoxazolines, dialdehydes such as glyoxal, acetoacetates, malonates, acetals, di- and trifunctional acrylates and thiols, cycloaliphatic epoxy molecules, organosilanes such as epoxysilanes and aminosilanes, carbamates, diamines and triamines, inorganic chelating agents such as certain zinc and zirconium salts, titaniums, glycourils and other aminoplasts. In certain cases, functional groups originating from other polymerization ingredients, such as surfactants, initiators, seed particles, may be involved in the crosslinking reaction. When two or more functional groups are involved in the crosslinking process, the pairs of complementary reactive groups are, for example, hydroxyl-isocyanate, acid-epoxy, amine-epoxy, hydroxyl-melamine, acetoacetate-acid.

The acrylate and/or methacrylate monomers not containing functional groups capable of entering into crosslinking reactions after the polymerization should preferably represent 70% or more by weight of the total mixture of monomers and, more preferably, should be greater than 90% by weight.

According to one embodiment, the fluoro-acrylic polymer resin comprises a crosslinking agent chosen from the group consisting of isocyanates, diamines, adipic acid, dihydrazides, and combinations thereof.

According to one embodiment, the fluoro-acrylic polymer resin does not crosslink and is provided in non-crosslinked form in the coating for a separator according to the invention.

The hybrid fluoro-acrylic polymer resin is an aqueous dispersion obtained by emulsion polymerization of from 5 to 100, preferably 5-95 parts by weight of a mixture of monomers having at least one monomer chosen from the group consisting of alkyl acrylates the alkyl groups of which have 1-18 carbon atoms and alkyl methacrylates the alkyl groups of which have 1-18 carbon atoms and optionally an ethylenically unsaturated compound copolymerizable with alkyl acrylates and alkyl methacrylates, in an aqueous medium in the presence of 100 parts by weight of particles of a vinylidene fluoride polymer as defined above. The PVDF particles serve as seed for the polymerization of the acrylic monomers.

The PVDF particles may be added to the polymerization system in any state so long as they are dispersed in an aqueous medium in the form of particles. Since the vinylidene fluoride polymer is generally produced in the form of an aqueous dispersion, it is practical for the aqueous dispersion such as that produced to be used as seed particles. The diameters of the vinylidene fluoride particles are within the range of preferably from 0.04 to 2.9 micrometres. In a preferred embodiment, the diameter of the polymer particles is preferably from 50 nm to 700 nm.

The product of the polymerization is a latex which may be used in this form, generally after filtering off the solid byproducts of the polymerization process. For the use in the form of a latex, the latex may be stabilized by the addition of a surface-active agent, which may be identical to or different from the surface-active agent present during the polymerization (where appropriate). This surfactant added later may, for example, be an ionic or nonionic surfactant.

The PVDF particles used as seed may have a homogeneous or heterogeneous nature or a gradient between the core and the surface of the particles, in terms of composition (content of HFP comonomer, for example) and/or of molecular weight.

In the hybrid fluoro-acrylic polymer resin, the PVDF/acrylic polymer mass ratio varies from 95/5 to 5/95, preferably from 75/25 to 25/75, advantageously from 60/40 to 40/60.

In the hybrid fluoro-acrylic polymer resin, the average diameter of the particles is from 0.05-3 preferably from 0.05-1 more preferentially from 0.1-1 μm.

The hybrid fluoro-acrylic polymer resin is characterized by an intimate intermingling between the fluoro polymer chains and the acrylic polymer chains.

The coating for a separator according to the invention contains, in addition to the hybrid fluoro-acrylic polymer resin described, inorganic particles which serve to form micropores in the coating (the interstices between inorganic particles). The assembly of these inorganic particles also contributes to the heat resistance.

According to one embodiment, said coating comprises from 50 to 99 percent by weight of inorganic particles, relative to the weight of the coating.

These inorganic particles must be electrochemically stable (not subject to oxidation and/or to reduction within the range of voltages used). In addition, the pulverulent inorganic materials preferably have a high ionic conductivity. Low-density materials are preferred to higher-density materials, since the weight of the battery produced can be reduced. The dielectric constant is preferably equal to or greater than 5.

According to one embodiment, said inorganic particles are chosen from the group consisting of: BaTiO₃, Pb(Zr,Ti)O₃, Pb₁₋ₓLaₓZr_{y}O₃ (0<x<1, 0<y<1), PBMg₃Nb_{2/3})₃, PbTiO₃, hafnia (HfO (HfO₂), SrTiO₃, SnO₂, CeO₂, MgO, NiO, CaO, ZnO, Y₂O₃, boehmite (y-AlO(OH)), Al₂O₃, TiO₂, SiC, ZrO₂, boron silicate, BaSO₄, nanoclays, or mixtures thereof.

In the coating for a separator according to the invention, the ratio of the solids of the polymer to the inorganic particles is from 0.5 to 30 parts by weight of solids of the hybrid fluoro-acrylic polymer resin per 70 to 99.5 parts by weight of inorganic particles, preferably from 0.5 to 25, then 0.5 to 20, then from 0.5 to 15, parts by weight of solids of the polymer per 85 to 99.5 parts by weight of inorganic particles, more preferably from 1 to 10 parts by weight of solids of the polymer per 90 to 99 parts by weight of inorganic particles, and in one embodiment from 0.5 to 8 parts by weight of solids of the polymer per 92 to 99.5 parts by weight of inorganic particles.

The coating for a separator of the invention may optionally comprise from 0 to 15 percent by weight, based on the polymer, and preferably 0.1 to 10 percent by weight, of additives, chosen from thickeners, pH-adjusting agents, anti-settling agents, surfactants, foaming agents, fillers, antifoam agents and fugitive or non-fugitive adhesion promoters.

The coating for a separator of the invention exhibits an excellent compromise of properties for the application of the coating for a separator via the aqueous route, as monolayer, with inorganic particles: a good dry adhesion, a good resistance to electrolyte solvent(s) characterized by good preserved integrity and moderate swelling, and a good Gurley permeability. Methods which may be used to characterize these properties are described in the examples.

The coating described above is used to coat the support of a separator, on at least one face, in the form of a monolayer.

Advantageously, the application of the coating according to the invention is done via the aqueous route.

A porous separator is coated on at least one face with the coating composition according to the invention. There is no particular limitation in the choice of the separator substrate which is coated with the aqueous coating composition of the invention, so long as it is a porous substrate having pores.

The porous substrate may take the form of a membrane or of a fibrous fabric. When the porous substrate is fibrous, it may be a nonwoven web forming a porous web, such as a web obtained by direct spinning or melt blowing (of spun bond or melt blown type).

Examples of porous substrates which are of use in the invention as separator comprise, without being limited thereto: polyolefins, polyethylene terephthalate, polybutylene terephthalate, polyester, polyacetal, polyamide, polycarbonate, polyimide, polyether ether ketone, polyether sulfone, poly(phenylene oxide), poly(phenylene sulfide), polyethylene naphthalate, or mixtures thereof. However, other engineering plastics that are resistant to heat may be used, without particular limitation. Non-woven materials made of natural or synthetic materials may also be used as the substrate of the separator.

The porous substrate generally has a thickness of from 1 to 50 μm, typically being membranes obtained by extrusion and drawing (wet or dry processes) or cast nonwovens. The porous substrate preferably has a porosity of between 5% and 95%. The average size of the pores (diameter) is preferably between 0.001 and 50 μm, more preferably between 0.01 and 10 μm.

According to one embodiment, a process for preparing a coated separator according to the invention comprises the following steps:
a) coating, via the aqueous route, at least one side of the separator with a monolayer coating as described above by dip coating, by spray coating, by gravure coating or by slot-die coating,
b) drying said coated separator at a temperature of from 25 to 85° C., to form a dry adhesive layer on the separator.

The implementation of the coating by the aqueous route makes it possible to obtain a porous/discontinuous coating having a permeable nature with regard to Li ions. The pores correspond to the interstices left between particles. The choice of the particles makes it possible to adjust the desired compromise of properties with, by way of guidance: inorganic particles which may improve the temperature resistance and polymer particles which may provide adhesion while resisting the electrolyte solvent(s).

According to one embodiment, the thickness of said coating over at least one side of the separator is from 0.5 to 10 micrometres.

The invention also relates to a separator for an electrochemical device chosen from the group: Li-ion battery, capacitor, electrical double-layer capacitor, and membrane-electrode assembly (MEA) for a fuel cell, said separator comprising a porous support and at least one monolayer coating as described above.

According to one embodiment, the invention relates to a separator for a Li-ion battery, coated with the adhesive monolayer coating described above.

The invention also relates to an electrochemical device chosen from the group: Li-ion battery, capacitor, electrical double-layer capacitor, and membrane-electrode assembly (MEA) for a fuel cell, said device comprising a separator coated with the adhesive monolayer coating described above.

The electrochemical device may be manufactured by any conventional method known to those skilled in the art. In one embodiment of the process for manufacturing the electrochemical device, the electrochemical device is provided by forming an assembly of electrodes from the porous organic/inorganic composite separator interposed between a cathode and an anode, and then injecting an electrolyte into the assembly.

Another subject of the invention is a Li-ion secondary battery comprising a negative electrode, a positive electrode and a separator, wherein said separator is coated with the adhesive monolayer coating described above.

### EXAMPLES

The following examples non-limitingly illustrate the scope of the invention.

The examples according to the invention and comparative examples described below were carried out according to the same protocol but using a different latex—or mixture of two latices—for each example. Table 1 summarizes the different latices used, their main characteristic, and the results obtained for each of them.

Preparation of the latices: A P(VDF-HFP) copolymer latex was used as seed for synthesizing a latex containing a fluoro-acrylic polymer composition by an emulsion polymerization process in the presence of a transfer agent of acrylic acid oligomer type of molar mass of less than 20 000 g/mol (Examples 1 and 2). The transfer agent makes it possible to incorporate acrylic acid functions into the P(VDF-HFP) copolymer. The solids content of this latex is approximately 30% to 40% by weight. The acrylic latex is obtained in the same way except that no seed is used. In Example 3, a P(VDF-HFP) copolymer latex was used as seed for synthesizing a latex containing a fluoro-acrylic polymer composition by an emulsion polymerization process in the presence of propane as transfer agent and of poly(ethylene glycol) as surfactant which does not introduce any functionalization as described in the present application.

Preparation of the aqueous formulation, at ambient temperature −22° C.: 10 g of alumina (Sumitomo Chemical AES-11) are added to 20 g of an aqueous 0.5% by weight CMC solution (Nippon paper FT-3), and then dispersed in a mixer (Filmix Model 40-L) for 30 sec at 30 m/s. To this dispersion are added the latex (or the two latices in the case of mixtures of PVDF latex and acrylic latex according to the ratio indicated in the table) so as to incorporate 4 g of the corresponding polymer(s) (amount of latex adjusted according to the solids content of each latex within the range 30-45%) and demineralized water to make up a total of 50 g of preparation. The mixture is then homogenized for 10 min with a vertical stirrer (IKA, Euro-ST) at 600 rpm. To 48 g of this mixture is added 0.24 g of wetting agent (BYK349) intended to facilitate spreading of the formulation over the separator, by mixing under the same conditions as for the latex. The dispersion obtained is stable and does not display any sedimentation visible to the eye after resting for 30 min.

Preparation of the coated separator: the aqueous formulation is applied at ambient temperature −22° C. using a manual applicator (bar coater, Hohsen Corp., wet deposition thickness −23 μm, manual application rate approximately 100 mm/sec) to a Celgard 2400 separator specimen (PP monolayer, thickness 25 μm, width 89 mm, length approximately 30 cm), and then dried on a hot plate for 10 min at 65° C. The dry deposit has a thickness measured at 5-6 μm depending on the specimens (Mitsutoyo Digimatic Indicator IDH053D micrometer). The separator obtained has a width of 89 mm and a length of 30 cm.

Gurley air permeability: the Gurley air permeability of each coated separator is measured (Gurley 4110N densometer with 4320EN auto-timer), and then the permeability of the support (measured at 575 sec/100 cc) is subtracted to obtain the permeability value for the coating indicated in Table 1. A coating permeability of <85 sec/100 cc is considered satisfactory.

Resistance to electrolyte solvents, evaluated via the swelling or even dissolution of the coating binder and/or the loss of integrity: a 50×60 mm specimen of each coated separator is weighed (W0) and them immersed in a mixture of electrolyte solvents EC/EMC=3/7 by volume, at ambient temperature −22° C., for 96 h. It is then removed from the bath, wiped on both of its faces, and then weighed (W1). Finally, it is placed in an oven at 120° C. for 24 h, and then weighed one final time (W2). The same operation is carried out with a specimen of the uncoated separator as reference, and results in the weights denoted W0ref, W1ref, W2ref. Lastly, since the coating contains 28.6% of polymer from the latex, the following values are calculated:

Weight gained by the polymer (%): [(W1−W1ref)−(W0−W0ref)]/(W0−W0ref)*100*0.286

Swelling of the polymer (%):[(W1−W1ref)−(W2−W2ref)]/(W2−W2ref)*100*0.286

Polymer extractable (dissolved) (%):[(W0−W0ref)−(W2−W2ref)]/(W0−W0ref)*100*0.286

These values assume that only the polymer from the latex swells or is dissolved by the electrolyte solvents, and that the alumina (predominant component of the coating) remains in the coating. Therefore, it is also visually checked whether solids or particles remain in the bath and/or whether the coating has detached from the separator support or readily detaches as a result of gentle rubbing with a finger (loss of integrity), in which case the resistance to electrolyte solvents is considered insufficient and no other indication (increase in weight, swelling, polymer extractable) is reported in the table.

Dry adhesion: a 40×90 mm coated separator specimen is brought into contact on its coated face with a cathode (NMC111 with PVDF binder, prepared by Elexcel). This assembly is then pressed between two rollers (Tester Sangyo, Model: SA-602) at 90° C. and 1.5 kgf/cm with a rate of 2.4 m/min in order to bond the coated separator and the cathode. The assembly is then cut to the dimensions 30×80 mm, and then fixed by the rear face of the cathode (aluminium collector) to a rigid metal support by virtue of a double-sided adhesive tape applied over the entire surface. On the other face, a single-sided adhesive tape is fixed to the coating of the separator, the adhesive tape protruding by a few centimetres. The free end of the single-sided adhesive tape and that of the metal supports are placed in the upper and lower jaws, respectively, of a tensile testing machine (Autograph AGS-X, 10 N load cell). The 180° peel test is carried out at ambient temperature (approximately 22° C.) at a rate of 50 mm/sec. The peel force (in N) is measured at the plateau of the curve. This value is related to the width of the specimen and then indicated in Table 1 (in N/m).

TABLE 1

| | | | | | Resistance | |
|---|---|---|---|---|---|---|
| | | | | | to | |
| | | | | | electrolyte | |
| | | | | | solvent | |
| | | % HFP | | | (% swelling | Gurley |
| | | in | PVDF/ | | of the | permeability |
| | | PVDF | Acrylic | Dry | polymer or | of the |
| | | (by | ratio (by | adhesion | loss of | coating |
| Example | Latex | weight) | weight) | (N/m) | integrity) | (dry/100 cc) |
| Ex. 1 | Functionalized | 6.5 | 70/30 | 1.9 | 140 | <85 |
| Ex. 2 | acrylated | 4.5 | 70/30 | 0.6 | 80 | |
| | PVDF | | | | | |
| CEx. 1 | PVDF | 6.5 | 100/0 | ~0 | 55 | |
| CEx. 2 | | 4.5 | 100/0 | ~0 | 30 | |
| CEx. 3 | Acrylic | — | 0/100 | 15 | Loss of | |
| | | | | | integrity | |
| CEx. 4 | Mixtures of | 6.5 | 70/30 | 5 | Loss of | |
| | PVDF latex | | | | integrity | |
| CEx. 5 | and acrylic | 4.5 | 70/30 | 5 | Loss of | |
| | latex | | | | integrity | |
| Ex. 3 | Acrylated PVDF | 4.5 | 70/30 | 0.4 | 85 | <85 |
| | without | | | | | |
| | functionalization | | | | | |

The coating for a separator according to the invention exhibits an excellent compromise of properties for the targeted application: a good dry adhesion, a good resistance to electrolyte solvent(s) characterized by a good preserved integrity and moderate swelling, and a good Gurley permeability.

In contrast, the comparative examples display at least one highly unfavourable property for each of the latices:
the PVDF latex alone exhibits a low dry adhesion;
the acrylic latex alone exhibits a low resistance to the electrolyte solvent, and
the mixture of these two types of latex exhibits a low resistance to the electrolyte solvent.

1. A monolayer coating for a separator, said coating comprising a hybrid fluoro-acrylic polymer resin and inorganic particles, said hybrid fluoro-acrylic polymer resin comprising a fluoropolymer and an acrylic polymer, the fluoropolymer being chosen from the group consisting of polyvinylidene fluoride homopolymers and copolymers based on vinylidene fluoride and on at least one comonomer compatible with the vinylidene fluoride.

2. The coating according to claim 1, wherein said comonomers compatible with vinylidene fluoride are chosen from the group consisting of: vinyl fluoride, tetrafluoroethylene, hexafluoropropylene, trifluoropropenes, tetrafluoropropenes, hexafluoroisobutylene, perfluorobutylethylene, pentafluoropropene, perfluoroalkyl vinyl ether, bromotrifluoroethylene, chlorofluoroethylene, chlorotrifluoroethylene, chlorotrifluoropropene and ethylene.

3. The coating according to claim 1, wherein said fluoropolymer is a polyvinylidene fluoride-hexafluoropropylene copolymer having a percentage by weight of hexafluoropropylene monomer units of from 2% to 23%, relative to the weight of the copolymer.

4. The coating according to claim 1, wherein said fluoropolymer comprises monomer units bearing at least one of the following functions: carboxylic acid, carboxylic acid anhydride, carboxylic acid ester, epoxy groups, amide, hydroxyl, carbonyl, mercapto, sulfide, oxazoline, phenolic, ester, ether, siloxane, sulfonic, sulfuric, phosphoric or phosphonic.

5. The coating according to claim 1, wherein the acrylic polymer contains a monomer chosen from the group consisting of methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, and combinations thereof.

6. The coating according to claim 1, wherein, in the hybrid fluoro-acrylic polymer resin, the fluoropolymer acrylic polymer mass ratio varies from 95/5 to 5/95.

7. The coating according to claim 1, wherein said inorganic particles are chosen from the group consisting of: BaTiO₃, Pb(Zr,Ti)O₃, Pb₁₋ₓLaₓZr_{y}O₃ (0<x<1, 0<y<1), PbMg₃Nb_{2/3}O₃, PbTiO₃, hafnia (HfO (HfO₂), SrTiO₃, SnO₂, CeO₂, MgO, NiO, CaO, ZnO, Y₂O₃, boehmite (y-AlO(OH)), Al₂O₃, TiO₂, SiC, ZrO₂, boron silicate, BaSO₄, nanoclays, or mixtures thereof.

8. The coating according to claim 1, comprising from 50 to 99 percent by weight of inorganic particles.

9. The coating according to claim 1, wherein the ratio of the solids of the hybrid fluoro-acrylic polymer to the inorganic particles is from 0.5 to 30 parts by weight of solids of the hybrid fluoro-acrylic polymer per 70 to 99.5 parts by weight of inorganic particles.

10. The coating according to claim 1, wherein the thickness of said coating over at least one side of the separator is from 0.5 to 10 micrometres.

11. A separator for an electrochemical device, said device selected from the group consisting of: Li-ion battery, capacitor, electrical double-layer capacitor, and membrane-electrode assembly (MEA) for a fuel cell, said separator comprising a porous support and at least one monolayer coating according to claim 1.

12. A process for preparing a coated separator, comprising the following steps:
a) coating, at least one side of the separator with a monolayer coating according to claim 1 by dip coating, by spray coating, by gravure coating or slot-die coating, wherein the hybrid fluoro-acrylic polymer resin and inorganic particles are in an aqueous medium during coating,
b) drying said coated separator at a temperature of from 25 to 85° C., to form a dry adhesive layer on the separator.

13. An electrochemical device chosen from the group consisting of: Li-ion battery, capacitor, electrical double-layer capacitor, and membrane-electrode assembly (MEA) for a fuel cell, said electrochemical device comprising a separator according to claim 11.

14. An Li-ion secondary battery comprising an anode, a cathode and a separator, wherein said separator is in accordance with claim 11.
